(19) United States
(12) Patent Application Publication
(10) Pub. No.: US 2020/0388798 A1
(43) Pub. Date: Dec. 10, 2020

(54) LITHIUM ION BATTERY POUCH CELL COPPER-FREE NEGATIVE TERMINAL TAB AND BATTERY PACK INCLUDING THE SAME

(71) Applicant: GM GLOBAL TECHNOLOGY OPERATIONS LLC, Detroit, MI (US)

(72) Inventors: Hongliang Wang, Sterling Heights, MI (US); James G. Schroth, Troy, MI (US); Fang Dai, Troy, MI (US); Evan J. Dawley, Bloomfield Hills, MI (US)

(21) Appl. No.: 16/430,935

(22) Filed: Jun. 4, 2019

(51) Int. Cl. H01M 2/02; H01M 10/0525; H01M 2/30; H01M 4/66; H01M 10/647; H01M 10/0585; H01M 2/32

(52) U.S. Cl. CPC H01M 2/0212; H01M 10/0525; H01M 2/30; H01M 2/1077; H01M 10/647; H01M 10/0585; H01M 2/32; H01M 4/661

(57) ABSTRACT

A lithium ion battery pouch cell is disclosed that includes a copper-free negative terminal tab in which at least a joining region of an exterior portion of the negative terminal tab is aluminum or nickel-coated aluminum. In this way, the negative terminal tab of the lithium ion battery pouch cell may be welded to a common aluminum bus bar along with a positive terminal tab of another lithium ion battery pouch cell, or the negative terminal tab and the positive terminal tab of the two lithium ion battery pouch cells may be directly welded together in the absence of a common bus bar. Because the negative terminal tab does not include copper, the difficulties inherent in welding aluminum and copper, such as the formation of brittle Al—Cu intermetallic compounds, can be avoided. Lithium ion battery packs that include the disclosed lithium ion battery pouch cell are also disclosed.

### INTRODUCTION

Lithium ion battery packs for vehicle and other high-power applications typically include multiple lithium ion battery pouch cells that are electrically connected together. Each pouch cell includes a plurality of lithium ion battery unit cells enclosed within a sealed pouch envelope. Each lithium ion battery unit cell, in turn, includes a negative electrode, a positive electrode, and a separator that physically separates and electrically isolates the negative and positive electrodes. To facilitate lithium ion mobility, an electrolyte that conducts lithium ions may be present within the separator. The electrolyte allows lithium ions to pass through the separator between the opposed electrodes in order to counterbalance the flow of electrons that, during charge and discharge cycles of the lithium ion battery unit cell, circumvent the separator and move between the electrodes through an external circuit. Depending on their chemistry, each lithium ion battery unit cell has a maximum or charging voltage (voltage at full charge) as a result of the difference in electrochemical potentials of the electrodes. For example, each lithium ion battery cell may have a charging voltage in the range of 3 V to 5 V and nominal open circuit voltage (midpoint between charging voltage and cell cutoff) in the range of 3.5 V to 4 V.

The lithium ion battery pouch cells may be connected in series, in parallel, or in series and in parallel depending on the specified battery pack design. To that end, each of the lithium ion battery pouch cells includes a negative terminal tab and a positive terminal tab. The two tabs extend through the sealed pouch envelope so that current can be delivered to and from pouch cells. Within the pouch cell, the negative terminal tab electrically communicates with the negative current collectors that contact and exchange electrons with the negative electrodes of the lithium ion battery unit cells, and, likewise, the positive terminal tab electrically communicates with the positive current collectors that contact and exchange electrons with the positive electrodes of the lithium ion battery unit cells. The negative current collectors and the negative terminal tabs have typically been composed of copper, and the positive current collectors and the positive terminal tabs have typically been composed of aluminum. Aluminum generally cannot be used to form the negative current collectors since aluminum will react with lithium ions at the negative electrode within the unit cell charging voltage range.

Bus bars have conventionally been used to connect the lithium ion battery pouch cells together. Aluminum is a particularly good candidate for constructing the bus bars. Indeed, aluminum is a highly electrically conductive and lightweight metal that is easy to process and also happens to be relatively inexpensive. However, the negative terminal tabs of the lithium ion battery pouch cells, which have conventionally been composed of copper, are not easily weldable to an aluminum bus bar. In particular, when a copper negative terminal tab is laser welded to an aluminum bus bar, brittle Al—Cu intermetallic compounds, such as Al₂Cu, tend to form at the aluminum-copper interface. These brittle Al—Cu intermetallic compounds are susceptible to fracture when the laser weld joint is loaded and, thus, may adversely affect the mechanical properties of the joint under various loading conditions, especially the lap shear strength of the joint. One proposed solution to the problem of welding aluminum and copper is to employ a bimetal bus bar comprised of an aluminum portion (for welding to the aluminum positive terminal tabs) and a copper portion (for welding to the copper negative terminal tabs). But such a bus bar is fabricated of copper and aluminum, thereby increasing the cost of the bus bar, and still requires its aluminum and copper portions to be joined, which is problematic for the reasons just mentioned. The ability to connect lithium ion battery pouch cells while avoiding the need to fusion weld aluminum and copper would be a noteworthy development.

### SUMMARY OF THE DISCLOSURE

A lithium ion battery pack according to one embodiment of the present disclosure includes a first group of lithium ion battery pouch cells and a second group of lithium ion battery pouch cells. Each of the lithium ion battery pouch cells in the first group comprises a negative terminal tab and a positive terminal tab. The negative terminal tab of each lithium ion battery pouch cell in the first group has an exterior portion that includes a joining region, and the positive terminal tab of each lithium ion battery pouch cell in the first group has an exterior portion that includes a joining region. The exterior portion of the positive terminal tab of each lithium ion battery pouch cell in the first group is composed of aluminum, and at least the joining region of the exterior portion of the negative terminal tab of each lithium ion battery pouch cell in the first group is composed of aluminum or nickel-coated aluminum. Similarly, each of the lithium ion battery pouch cells in the second group comprises a negative terminal tab and a positive terminal tab. The negative terminal tab of each lithium ion battery pouch cell in the second group has an exterior portion that includes a joining region, and the positive terminal tab of each lithium ion battery pouch cell in the second group has an exterior portion that includes a joining region. The exterior portion of the positive terminal tab of each lithium ion battery pouch cell in the second group is composed of aluminum, and at least the joining region of the exterior portion of the negative terminal tab of each lithium ion battery pouch cell in the second group is composed of aluminum or nickel-coated aluminum. The positive terminal tabs of the first group of lithium ion battery pouch cells are electrically connected to the negative terminal tabs of the second group of lithium ion battery pouch cells.

The lithium ion battery pack of the aforementioned embodiment may include additional features or be further defined. For example, the lithium ion battery back may further comprise an aluminum bus bar. The joining region of the exterior portion of the positive terminal tab of each lithium ion battery pouch cell in the first group may be welded to the aluminum bus bar, and the joining region of the exterior portion of the negative terminal tab of each lithium ion battery pouch cell in the second group may also be welded to the aluminum bus bar. Further, the joining regions of the exterior portions of the positive terminal tabs of the lithium ion battery pouch cells in the first group may be stacked together and overlap, and a weld joint may weld the joining regions of the exterior portions of the positive terminal tabs of the lithium ion battery pouch cells in the first group to each other as well as to the aluminum bus bar. Likewise, the joining regions of the exterior portions of the negative terminal tabs of the lithium ion battery pouch cells in the second group may be stacked together and overlap, and a weld joint may weld the joining regions of the exterior portions of the negative terminal tabs of the lithium ion battery pouch cells in the second group to each other as well as to the aluminum bus bar. In another example, the joining regions of the exterior portions of the positive terminal tabs of the lithium ion battery pouch cells in the first group are welded directly to the joining regions of the exterior portions of the negative terminal tabs of the lithium ion battery pouch cells in the second group.

In still another example, the negative terminal tab of each lithium ion battery pouch cell of the second group may include a nickel segment and an aluminum segment. The nickel segment may be electrically connected to a plurality of lithium ion battery unit cells within an envelope of its respective lithium ion battery pouch cell and may further extend through the envelope of its respective lithium ion battery pouch cell. The aluminum segment may be joined to and extend from the nickel segment to provide the joining region of the exterior portion of the negative terminal tab of its respective lithium ion battery pouch cell. Additionally, the aluminum segment of the negative terminal tab of each lithium ion battery pouch cell may comprise a majority of the exterior portion of the negative terminal tab of its respective lithium ion battery pouch cell. In yet another example, at least the interior portion of the negative terminal tab of each lithium ion battery pouch cell of the second group is composed of nickel-coated aluminum. To that end, in one implementation, the negative terminal tab of each lithium ion battery pouch cell of the second group may be composed entirely of nickel-coated aluminum.

The lithium ion battery pack of the aforementioned embodiment may additionally include a third group of lithium ion battery pouch cells. Each of the lithium ion battery pouch cells in the third group comprises a negative terminal tab and a positive terminal tab. The negative terminal tab of each lithium ion battery pouch cell in the third group has an exterior portion that includes a joining region, and the positive terminal tab of each lithium ion battery pouch cell in the third group has an exterior portion that includes a joining region. The exterior portion of the positive terminal tab of each lithium ion battery pouch cell in the third group is composed of aluminum, and at least the joining region of the exterior portion of the negative terminal tab of each lithium ion battery pouch cell in the third group is composed of aluminum or nickel-coated aluminum. The positive terminal tabs of the second group of lithium ion battery pouch cells are electrically connected to the negative terminal tabs of the third group of lithium ion battery pouch cells.

A lithium ion battery pack according to another embodiment of the present disclosure includes a first group of lithium ion battery pouch cells and a second group of lithium ion battery pouch cells. Each of the first group of lithium ion battery pouch cells has a positive terminal tab that includes an exterior portion composed of aluminum, and, likewise, each of the second group of lithium ion battery pouch cells has a negative terminal tab that includes an exterior portion. At least part of the exterior portion of the negative terminal tab of each lithium ion battery cell in the second group is composed of aluminum or nickel-coated aluminum. Also, the exterior portion of each positive terminal tab and the part of the exterior portion of each negative terminal tab that is composed of aluminum or nickel-coated aluminum are welded to a common aluminum bus bar or are directly welded together.

The lithium ion battery pack of the aforementioned embodiment may include additional features or be further defined. For example, the negative terminal tab of at least one lithium ion battery pouch cell of the second group may include a nickel segment and an aluminum segment. The nickel segment may be electrically connected to a plurality of lithium ion battery unit cells within an envelope of its respective lithium ion battery pouch cell and may further extend through the envelope of its respective lithium ion battery pouch cell. The aluminum segment may be joined to and extend from the nickel segment. In another example, the negative terminal tab of at least one lithium ion battery pouch cell of the second group may be entirely composed of nickel-coated aluminum. In yet another example, the negative terminal tab of at least one lithium ion battery pouch cell of the second group may include an interior portion, and at least the interior portion of the negative terminal tab may be composed of nickel-coated aluminum. And, in still another example, each of the lithium ion battery pouch cells in the second group may further comprise a positive terminal tab that includes an exterior portion composed of aluminum, and the lithium ion battery may further comprise a third group of lithium ion battery pouch cells. Each of the third group of lithium ion battery pouch cells may have a negative terminal tab that includes an exterior portion. At least part of the exterior portion of the negative terminal tab of each lithium ion battery pouch cell in the third group may be composed of aluminum or nickel-coated aluminum. The exterior portions of positive terminal tabs of the second group of lithium ion battery pouch cells and the parts of the exterior portions of the negative terminal tabs of the lithium ion battery pouch cells in the third group that are composed of aluminum or nickel-coated aluminum may be welded to a common aluminum bus bar or may be directly welded together.

A lithium ion battery pouch cell is also disclosed. According to one embodiment of the present disclosure, the lithium ion battery pouch cell comprises an envelope. The pouch cell also comprises a plurality of lithium ion battery unit cells enclosed within the envelope. Each of the lithium ion battery unit cells comprises a positive electrode, a negative electrode, and a separator disposed between the positive and negative electrodes. The pouch cell additionally comprises a plurality of positive-side metal current collectors that are in contact with and exchange electrons with the positive electrodes of the plurality of lithium ion battery unit cells, and a plurality of negative-side metal current collectors that are in contact with and exchange electrons with the negative electrodes of the plurality of lithium ion battery unit cells. Still further, the pouch cell comprises a positive terminal tab that electrically communicates with the positive-side metal current collectors inside the envelope. The positive terminal tab extends through the envelope and has an exterior portion outside of the envelope, and is further composed of aluminum. The pouch cell also includes a negative terminal tab that electrically communicates with the negative-side metal current collectors inside the envelope. The negative terminal tab extends through the envelope and has an exterior portion outside of the envelope. At least a part of the exterior portion of the negative terminal tab is composed of aluminum or nickel-coated aluminum.

The lithium ion battery pouch cell of the aforementioned embodiment may include additional features or be further defined. For instance, the negative terminal tab may include a nickel segment and an aluminum segment. The nickel segment may be electrically connected to the negative-side metal current collectors within the envelope and may further extend through the envelope to provide part of the exterior portion of the negative terminal tab, and the aluminum segment may be joined to and extend from the nickel segment to provide a remainder of the exterior portion of the negative terminal tab. As another example, the negative terminal tab may be composed of nickel-coated aluminum.

### BRIEF DESCRIPTION OF THE DRAWINGS

FIG. 1 is a schematic perspective view of a lithium ion battery pouch cell according to one embodiment of the present disclosure;

FIG. 2 is a cross-sectional view of the lithium ion battery pouch cell depicted in FIG. 1, taken along section lines 2-2, which shows several exaggerated and idealized versions of the plurality of lithium ion battery unit cells contained within the lithium ion battery pouch cell according to one embodiment of the present disclosure;

FIG. 3 is a representative illustration of several negative-side and positive-side metal current collectors included within the pouch envelope as well as the connections of the negative-side metal current collectors and the positive-side metal current collectors to the negative terminal tab and the positive terminal tab of the pouch cell, respectively, according to one embodiment of the present disclosure;

FIG. 4 is a cross-sectional view of a negative terminal tab of a lithium ion battery pouch cell according to one embodiment of the present disclosure;

FIG. 5 is a cross-sectional view of a negative terminal tab of a lithium ion battery pouch cell according to another embodiment of the present disclosure;

FIG. 6 is a cross-sectional view of a negative terminal tab of a lithium ion battery pouch cell according to still another embodiment of the present disclosure;

FIG. 7 is a schematic illustration of a lithium ion battery pack in which a plurality of lithium ion battery pouch cells are electrically connected together by aluminum bus bars according to one embodiment of the present disclosure; and

FIG. 8 is a schematic illustration of a lithium ion battery pack in which a plurality of lithium ion battery pouch cells are directly electrically connected together without using bus bars according to another embodiment of the present disclosure.

### DETAILED DESCRIPTION

The present disclosure is directed to a lithium ion battery pouch cell and a larger lithium ion battery pack that includes a plurality of individual pouch cells electrically connected together. The lithium ion battery pouch cell includes a negative terminal tab and a positive terminal tab. An exterior portion of the positive terminal tab, and preferably the entire positive terminal tab, is composed of aluminum, while at least a part of an exterior portion of the negative terminal tab is composed of aluminum or nickel-coated aluminum. The negative terminal tab and the positive terminal tab can thus be welded to a common aluminum bus bar, or directly welded to each other in the absence of an aluminum bus bar, without having to weld dissimilar aluminum and copper materials or contend with the resultant brittle Al—Cu intermetallics that are formed in the process. As such, a lithium ion battery pack is less susceptible to failure or certain performance declines that may result when an individual pouch cell becomes disconnected from the rest of the pouch cells. The battery pack is also simpler in design and less expensive to manufacture. The lithium ion battery pack may contain enough lithium ion battery pouch cells and be configured to present the voltage, energy density, and power needed to propel various types of electric vehicles—most notably battery electric vehicles (BEVs) and hybrid electric vehicles (HEVs)—among other high-power applications.

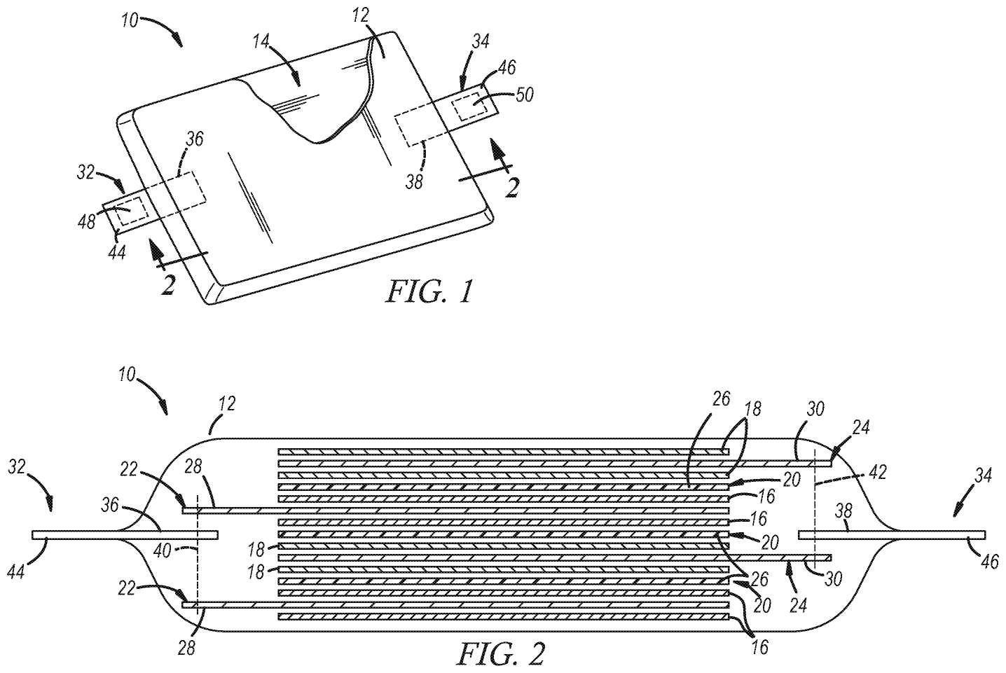

A lithium ion battery pouch cell 10 according to one embodiment of the present disclosure is illustrated in in FIGS. 1-3. The lithium ion battery pouch cell 10 includes a flexible envelope or pouch 12 that is sealed to enclose a plurality of stacked-up lithium ion battery unit cells 14. The envelope 12 may be an aluminum laminated foil. Each of the lithium ion battery unit cells 14 includes a negative electrode 16, a positive electrode 18, and a separator 20 disposed between the electrodes 16, 18 to physically separate and electrically insulate the electrodes 16, 18 from each other, as shown in FIG. 2. An electrolyte that conducts lithium ions is contained within the separator 20 and is exposed to each electrode 16, 18 to permit lithium ions to move between the electrodes 16, 18. Additionally, the negative electrode 16 of each lithium ion battery unit cell 14 contacts and exchanges electrons with a negative-side metal current collector 22, and the positive electrode 18 of each lithium ion battery unit cell 14 contacts and exchanges electrons with a positive-side metal current collector 24. The lithium ion battery unit cells 14 are typically stacked so that each negative-side current collector 22 is interposed between a negative electrode 16 of one unit cell 14 and a negative electrode 16 of an adjacent unit cell 14 and, similarly, each positive-side current collector 24 is interposed between a positive electrode 18 of one unit cell 14 and a positive electrode 18 of an adjacent unit cell 14. At least one, and, for vehicle applications, typically anywhere from one to 100, lithium ion battery unit cells 14 may be included in the pouch cell 10.

The negative electrode 16 and the positive electrode 18 of each lithium ion battery unit cell 14 is comprised of an electrode material that is able to intercalate and deintercalate lithium ions. The electrode materials of the two electrodes 16, 18 are formulated to store intercalated lithium at different electrochemical potentials relative to a common reference electrode (typically lithium). In the construct of the lithium ion battery unit cell 14, the negative electrode 16 stores intercalated lithium at a lower electrochemical potential (i.e., a higher energy state) than the positive electrode 18 such that an electrochemical potential difference exists between the electrodes 16, 18 when the negative electrode 16 is lithiated. The electrochemical potential difference for each lithium ion battery cell 14 results in a charging voltage in the range of 3 V to 5 V and nominal open circuit voltage in the range of 3.5 V to 4 V. These attributes of the negative and positive electrodes 16, 18 permit the reversible transfer of lithium ions between the two electrodes 16, 18 either spontaneously (discharge phase) or through the application of an external voltage (charge phase) during operational cycling of the unit cell 14. The thickness of each electrode 16, 18 typically ranges from 30 μm to 150 μm.

The negative electrode 16 comprises a lithium host material such as, for example, graphite, silicon, or lithium titanate. The lithium host material may be intermingled with a polymeric binder material to provide the negative electrode 16 with structural integrity and, optionally, a conductive fine particle diluent. The lithium host material is preferably graphite and the polymeric binder material is preferably one or more of polyvinylidene fluoride (PVdF), an ethylene propylene diene monomer (EPDM) rubber, styrene butadiene rubber (SBR), a carboxymethyl cellulose (CMC), polyacrylic acid, or mixtures thereof. Graphite is normally used to make the negative electrode 16 because, on top of being relatively inert, its layered structure exhibits favorable lithium intercalation and deintercalation characteristics which help provide the lithium ion battery unit cell 14 with a suitable energy density. Commercial forms of graphite that may be used to construct the negative electrode 16 are available from Timcal Graphite and Carbon (headquartered in Bodio, Switzerland), Lonza Group (headquartered in Basel, Switzerland), and Superior Graphite (headquartered in Chicago, Ill.). The conductive diluent may be very fine particles of, for example, high-surface area carbon black.

The positive electrode 18 comprises a lithium-based active material that stores intercalated lithium at a higher electrochemical potential (relative to a common reference electrode) than the lithium host material used to make the negative electrode 16. The same polymeric binder materials (PVdF, EPDM, SBR, CMC, polyacrylic acid) and conductive fine particle diluent (high-surface area carbon black) that may be used to construct the negative electrode 16 may also be intermingled with the lithium-based active material of the positive electrode 18 for the same purposes. The lithium-based active material is preferably a layered lithium transition metal oxide, such as lithium cobalt oxide (LiCoO₂), a spinel lithium transition metal oxide, such as spinel lithium manganese oxide (LiMn₂O₄), a lithium polyanion, such as a nickel-manganese-cobalt oxide [Li(Ni_{X}Mn_{Y}CO_{Z})O₂], lithium iron phosphate (LiFePO₄), or lithium fluorophosphate (Li₂FePO₄F). Some other suitable lithium-based active materials that may be employed as the lithium-based active material include lithium nickel oxide (LiNiO₂), lithium aluminum manganese oxide (Li_{X}Al_{Y}Mn_{1-Y}O₂), and lithium vanadium oxide (LiV₂O₅), to name but a few alternatives. Mixtures that include one or more of these recited lithium-based active materials may also be used to make the positive electrode 18.

The separator 20 comprises one or more porous polymer layers 26 that, individually, may be composed of any of a wide variety of polymers. Only one such polymer layer 26 is shown here for simplicity. Each of the one or more polymer layers 26 may be a polyolefin. Some specific examples of a polyolefin are polyethylene (PE) (along with variations such as HDPE, LDPE, LLDPE, and UHMWPE), polypropylene (PP), or a blend of PE and PP. The polymer layer(s) 26 function to electrically insulate and physically separate the negative and positive electrodes 16, 18. The separator 20 may further be infiltrated with a liquid electrolyte throughout the porosity of the polymer layer(s) 26. The liquid electrolyte, which also wets both electrodes 16, 18, preferably includes a lithium salt dissolved in a non-aqueous solvent. The lithium salt may be LiClO₄, LiAlCl₄, LiI, LiBr, LiSCN, LiBF₄, LiB(C₆H₅)₄, LiAsF₆, LiCF₃SO₃, LiN(CF₃SO₂)₂, LiPF₆, or a mixture that includes one or more of these salts, and the non-aqueous solvent may be a cyclic carbonate (i.e., ethylene carbonate, propylene carbonate), an acyclic carbonate (i.e., dimethyl carbonate, diethyl carbonate, ethylmethylcarbonate), an aliphatic carboxylic ester (i.e., methyl formate, methyl acetate, methyl propionate), a γ-lactone (i.e., γ-butyrolactone, γ-valerolactone), an acyclic ether (i.e., 1,2-dimethoxyethane, 1,2-diethoxyethane, ethoxymethoxyethane), a cyclic ether (i.e., tetrahydrofuran, 2-methyltetrahydrofuran), or a mixture that includes one or more of these solvents. The thickness of the separator 20 typically ranges from 10 μm to 50 μm.

The descriptions set forth above pertaining to the negative electrode 16, the positive electrode 18, the separator 20, and the electrolyte included within the separator 20 are intended to be non-limiting examples of those aspects of the lithium ion battery unit cell 14. It should be appreciated that many variations on the chemistry of each component 16, 18, 20 are known and may be applied in the context of the lithium ion battery pouch cell 10 of the present disclosure. For example, the lithium host material of the negative electrode 16 and lithium-based active material of the positive electrode 18 may be compositions other than those specific electrode materials listed above, particularly as lithium ion battery electrode materials continue to be researched and developed. Additionally, the polymer layer(s) 26 and/or the electrolyte contained within the polymer layer(s) 26 of the separator 20 may also include other polymers and electrolytes than those specifically listed above. In one variation, the separator 20 may be a solid polymer electrolyte that includes a polymer layer—such polyethylene oxide (PEO), polypropylene oxide (PPO), polyacrylonitrile (PAN), or polyvinylidene fluoride (PVdF)—that is complexed with a lithium salt or swollen with a lithium salt solution. However constructed and whatever materials are used, the lithium ion battery unit cell 14 need only be able to reversibly exchange lithium ions through the separator 20 and a flow of electrons around the separator 20 during applicable discharge and charge cycles.

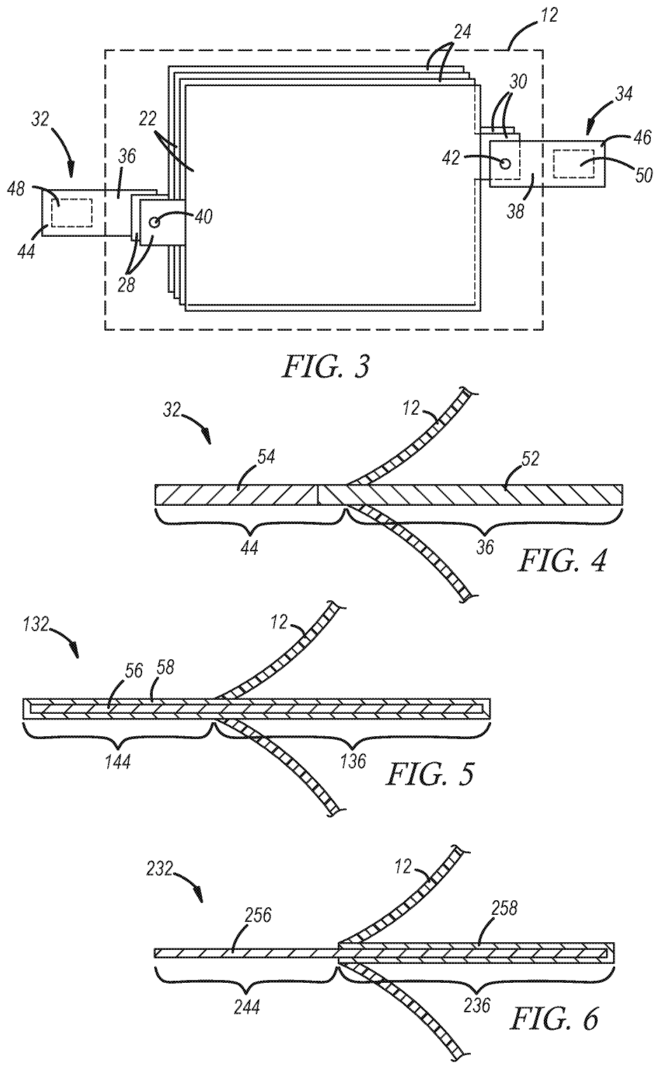

The negative-side and positive-side metal current collectors 22, 24 may be thin metallic foils that contact their respective negative and positive electrodes 16, 18 over an appreciable interfacial surface area. The purpose of these metal current collectors 22, 24 is to exchange free electrons with their respective positive and negative electrodes 16, 18 during discharging and charging of the lithium ion battery unit cells 14. The thickness of each of the negative-side and the positive-side metal current collectors 22, 24 is typically between 5 μm and about 25 μm. To facilitate the collective distribution and flow of electrons, each of the negative-side metal current collectors 22 includes a negative connection tab 28, and each of the positive-side metal current collectors 24 includes a positive connection tab 30. As shown representatively in FIGS. 2 and 3, the negative connection tabs 28 protrude away from the lithium ion battery unit cells 14 and are positioned in overlapping alignment with one another, and the positive connection tabs 30 also protrude away from the lithium ion battery unit cells 14 and are positioned in overlapping alignment with one another. The aligned sets of negative and positive connection tabs 28, 30 are separated from each other either on different sides (as shown) or the same side of the lithium ion battery unit cells 14.

The lithium ion battery pouch cell 10 includes a negative terminal tab 32 and a positive terminal tab 34. Within the pouch envelope 12, the negative terminal tab 32 electrically communicates with the negative-side current collectors 22 and the positive terminal tab 34 electrically communicates with the positive-side current collectors 24. Specifically, in this particular embodiment, an interior portion 36 of the negative terminal tab 32 is connected to the negative connection tabs 28 and an interior portion 38 of the positive terminal tab 34 is connected to the positive connection tabs 30. The interior portions 36, 38 of the negative and positive terminal tabs 32, 34 are those portions of the tabs 32, 34 that are contained within the sealed pouch envelope 12 of the lithium ion battery pouch cell 14. The interior portions 36, 38 of the negative and positive terminal tabs 32, 34 are preferably connected to the negative and positive connection tabs 28, 30, respectively, by a weld joint 40, 42 (FIGS. 2 and 3), each of which may be a solid-state weld joint formed through ultrasonic welding or a fusion weld joint formed through laser welding, although other metal-to-metal joining procedures may of course be employed. The weld joints 40, 42 are depicted in FIG. 2 as dashed lines since the connection tabs 28, 30 are spaced apart and separated so that the various components of the unit cells 14 can be better visualized.

The negative and positive terminal tabs 32, 34 also extend through the sealed envelope 12 so that external electrical connections can be made to the pouch cell 14. To that end, the negative terminal tab 32 includes an exterior portion 44 disposed outside of the sealed pouch envelope 12, and the positive terminal tab 34 includes an exterior portion 46 disposed outside of the sealed pouch envelope 12. Each of the exterior portion 44 of the negative terminal tab 32 and the exterior portion 46 of the positive terminal tab 34 contains a joining region 48, 50, as shown best in FIGS. 1 and 3, where the tab 32, 34 may be welded, for example, by laser welding with an appropriate laser beam. To ensure that at least the joining region 50 of the exterior portion 46 of the positive terminal tab 34 is composed of aluminum, the entire positive terminal tab 34, i.e., both the interior portion 38 and the exterior portion 46, is preferably composed of aluminum. Forming the positive terminal tab 34 from aluminum is practical and convenient since the positive-side metal current collectors 24, including their positive connection tabs 30, are typically and preferably also composed of aluminum. In the present disclosure, however, the negative terminal tab 32 and the negative-side metal current collectors 22 are not formed of copper in the customary way. This obviates the need to have to weld copper and aluminum materials together in some way or another.

The negative-side metal current collectors 22 are preferably composed of copper, and the negative terminal tab 32 is constructed so that at least the joining region 48 of the exterior portion 44 of the tab 32 is composed of aluminum or nickel-coated aluminum. For instance, in one embodiment, which is shown best in FIG. 4, the negative terminal tab 32 may include a nickel segment 52 and an aluminum segment 54. The nickel segment 52 constitutes the interior portion 36 of the negative terminal tab 32, and is thus electrically connected to the negative-side metal current collectors 22 within the pouch envelope 12, and further constitutes a part of the exterior portion 44 of the tab 32. The aluminum segment 54 is joined to and extends from the nickel segment 52 to provide the remainder of the exterior portion 44 of the negative terminal tab 32 including the joining region 48. In this way, only the nickel segment 52 is exposed to the electrolyte within the sealed pouch envelope 12, which is acceptable since nickel is stable in that environment, while the aluminum segment 54 is made available for connecting the pouch cell 10 within a lithium ion battery pack, as will be further explained below. The aluminum segment 54 may comprise a majority of the exterior portion 44 of the negative terminal tab 32 and may be joined to the nickel segment 52 by laser welding. The welding of nickel to aluminum is not overly problematic here since equilibrium Al—Ni intermetallic compounds have larger formation enthalpies compared to those of Al—Cu intermetallic compounds, meaning that the Al—Ni intermetallics that form during fusion welding are not as brittle as Al—Cu intermetallics. The welding of copper to nickel, which may be required when welding the negative connection tabs 28 to the nickel segment 52 of the negative terminal tab 32, is also less problematic than welding aluminum to copper.

In another embodiment, and as shown in FIG. 5, the negative terminal tab, which is identified by reference numeral 132, may be composed of nickel-coated aluminum. In this discussion, features of the negative terminal tab 132 that are the same as those in the previously-described embodiment are identified with corresponding 100 series reference numerals to indicate that the previous discussion of those features applies equally to this embodiment. Here, each of the interior portion 136 and the exterior portion 144 (inclusive of the joining region) of the negative terminal tab 132 are composed of nickel-coated aluminum. The entire negative terminal tab 132 includes an aluminum core 56 and a nickel coating 58 that covers an exterior of the aluminum core 56. The nickel coating 58 is a thin film coating that has a thickness ranging in many instances from 1 nm to 25 μm or, more narrowly, from 2 μm to 10 μm, and may be applied to the aluminum core 56 by electroplating, dip coating, physical vapor deposition processes such as sputtering, and plasma vapor deposition processes such as magnetron sputtering, among others. The negative terminal tab 132 of this embodiment is stable within the sealed pouch envelope 12 since the unreactive nickel coating 58 shields and protects the underlying aluminum core 56 from exposure to lithium ions and the electrolyte. And, compared to copper, the nickel-coated aluminum of the negative terminal tab 132 is also more weldable to other materials that include aluminum since, as noted above, the Al—Ni intermetallics that form during fusion welding are not as brittle as Al—Cu intermetallics.

The negative terminal tab 132 may be manufactured to ensure that no portion of the aluminum core 56 is uncovered by the nickel coating 58. In current manufacturing processes, negative terminal tabs are cut to the desired length from a larger sheet metal substrate. If the larger sheet metal substrate is an aluminum sheet that is coated with nickel prior to cutting, the negative terminal tabs would include edges obtained from previously-interior portions of the sheet substrate that present bare aluminum. This would be problematic within the sealed pouch envelope since lithium would react with the exposed aluminum of the negative tabs. To address this potential issue, an aluminum sheet metal substrate can be unwound from a reel and punched or stamped to define individual negative terminal tabs that are connected along an edge of the substrate but are otherwise separated by notches. The sheet substrate is then pulled through an electroplating bath or other thin-film coating station and, at that time, a nickel coating is applied to the negative terminal tabs contained in the sheet substrate. The negative terminal tabs can then be cut from the edge of the sheet substrate with the end that is opposite from the end that was cut from the sheet substrate edge being disposed within the sealed pouch envelope and joined to the negative connection tabs. As such, no surface of the interior portion 136 of the negative terminal tab 132 is left uncovered by the nickel coating 58.

In still another embodiment, and as shown in FIG. 6, the negative terminal tab, which is identified by reference numeral 232, may be partially coated with nickel. In this discussion, similar to before, features of the negative terminal tab 232 that are the same as those in the previously-described embodiments are identified with corresponding 200 series reference numerals to indicate that the previous discussion of those features applies equally to this embodiment. Here, at least the interior portion 236 of the negative terminal tab 232 is nickel-coated aluminum; that is, the negative terminal tab 232 includes an aluminum core 156 and a nickel coating 158 that coats at least the portion of the aluminum core 156 that constitutes the interior portion 236 of the negative terminal tab 232. The portion of the aluminum core 156 that constitutes the exterior portion 244 of the negative terminal tab 232 may, as shown, be bare (i.e., uncoated by the nickel coating 258) or partially-coated by the nickel coating 258 as the nickel coating may continue from the interior portion 236, through the pouch envelope 12, and may form part of the exterior portion 244 of the tab 232 before terminating. In this scenario, the interior portion 236 of the negative terminal tab 232 would be composed of nickel-coated aluminum, while the joining region of the exterior portion 244 of the tab 232 could be nickel-coated aluminum or bare aluminum depending on the extent to which the exterior portion 244 of the tab 232 includes the nickel coating 258. The negative terminal tab 232 of this embodiment may be manufactured similar to the tab 132 of the previous embodiment with the exception that the aluminum sheet metal substrate is selectively plated, masked, or processed in some other suitable manner to achieve the partial nickel coating 258 as desired.

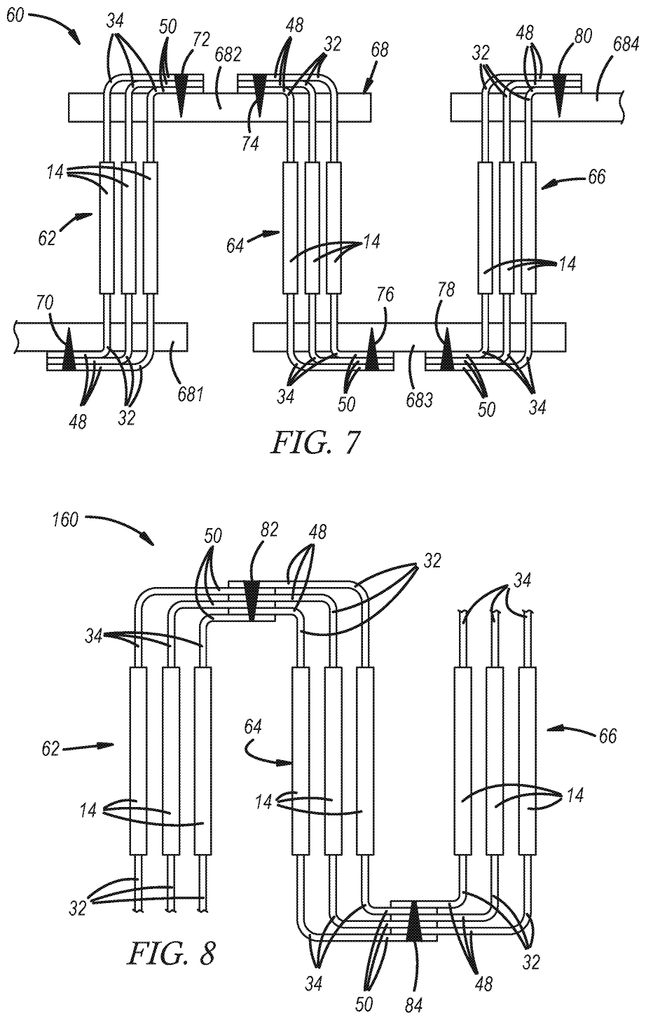

The negative terminal tab 32, 132 can be joined to the negative connection tabs 28 by way of ultrasonic welding, as described above, and can additionally be fusion or solid-state welded to a common aluminum bus bar, or directly fusion welded to each other, to build a lithium ion battery pack. Two examples of a lithium ion battery pack 60, 160 that includes a plurality of lithium ion battery pouch cells 14 electrically connected together is shown schematically in FIGS. 7-8. In these figures, a first group 62 of lithium ion battery pouch cells 14, a second group 64 of lithium ion battery pouch cells 14, and a third group 66 of lithium ion battery pouch cells are illustrated, although it should be understood that the lithium ion battery pack 60, 160 may include additional groups of pouch cells 14 in order to satisfy specified voltage and power requirements. Moreover, the description of the lithium ion battery pouch cell 14 provided above applies equally to each of the lithium ion battery pouch cells 14 included in the first, second, and third groups 62, 64, 66 of pouch cells 14. The various pouch cells 14 do not have to be identical, however, as some of the pouch cells 14 may include the negative terminal tab 32 that includes a nickel segment 52 and an aluminum segment 54 while others may include the negative terminal tab 132 that is composed partially or entirely of nickel-coated aluminum.

Referring to the embodiment of the lithium ion battery back 60 shown in FIG. 7, each of the first group 62, the second group 64, and the third group 66 of lithium ion battery pouch cells 14 includes three pouch cells 14. The pouch cells 14 within each group 62, 64, 66 are connected in parallel (3P architecture), and, in turn, the three groups 66, 64, 66 of pouch cells 14 are connected in series. The parallel and series connections are accomplished using aluminum bus bars 68. In particular, the joining regions 48 of the exterior portions 44 of the negative terminal tabs 32 of the first group 62 of lithium ion battery pouch cells 14 are fusion welded to a first aluminum bus bar 681, and the joining regions 50 of the exterior portions 46 of the positive terminal tabs 34 of the first group 62 of lithium ion battery cells 14 are fusion welded to a second aluminum bus bar 682 to connect the pouch cells 14 of the first group 62 in parallel. Similarly, the joining regions 48 of the exterior portions 44 of the negative terminal tabs 32 of the second group 64 of lithium ion battery pouch cells 14 are fusion welded to the second aluminum bus bar 682, and the joining regions 50 of the exterior portions 46 of the positive terminal tabs 34 of the second group 64 of lithium ion battery cells 14 are fusion welded to a third aluminum bus bar 683 to connect the pouch cells 14 of the second group 64 in parallel and also to connect the first and second groups 62, 64 of lithium ion battery pouch cells 14 in series.

Still further, the joining regions 48 of the exterior portions 44 of the negative terminal tabs 32 of the third group 66 of lithium ion battery pouch cells 14 are fusion welded to the third aluminum bus bar 683, and the joining regions 50 of the exterior portions 46 of the positive terminal tabs 34 of the third group 66 of lithium ion battery cells 14 are fusion welded to a fourth aluminum bus bar 684 to connect the pouch cells 14 of the third group 64 in parallel and also to connect the second and third groups 64, 66 of lithium ion battery pouch cells 14 in series. The fusion welding of the various negative and positive terminal tabs 32, 34 to their respective aluminum bus bars 681, 682, 683, 684 is easier to accomplish and more reliable than attempting to weld both aluminum (positive) and copper (negative) terminal tabs to bimetallic aluminum/copper bus bars, or to weld both aluminum and copper terminal tabs to a common aluminum or a common copper bus bar, in accordance with conventional procedures. Not only does the presently-disclosed battery pack architecture avoid having to weld aluminum to copper within the bimetallic bus bars, which results in the formation of brittle Al—Cu intermetallic compounds at the joint interface, but it also avoids having to weld copper-to-copper. This is noteworthy since aluminum has a higher energy absorptivity at laser beam wavelengths than copper and also has a lower melting point than copper. In that regard, aluminum can be welded using a comparatively lower energy input, which helps prevent thermal damage to the battery pack.

The weld joints 70, 72, 74, 76, 78, 80 that fusion weld the negative and positive terminal tabs 32, 34 of each group 62, 64, 66 of pouch cells 14 to their respective aluminum bus bars 68 (681, 682, 683, 684) may be formed by laser welding. And since the pouch cells 14 within each group 62, 64, 66 are connected in parallel, the joining regions 48 of the exterior portions 44 of the negative terminal tabs 32 of each group 62, 64, 66 may be stacked together so that they overlap. By stacking the negative terminal tabs 32, the laser welding process can be performed so that the weld joints 70, 74, 78 extend through the joining regions 48 of the stacked exterior portions 44 of the tabs 32 of each group 62, 64, 66 and into their respective aluminum bus bars 681, 682, 683, as shown here. This results in a single weld joint 70, 74, 78 fusion welding all of the negative terminal tabs 32 within each group 64, 64, 66 of pouch cells 14 to the applicable aluminum bus bars 681, 682, 683. The same stacking and welding practice may also be carried out with the positive terminal tabs 34 of each group 62, 64, 66 of lithium ion battery pouch cells 14. That is, the exterior portions 46 of the positive terminal tabs 34 within each group 62, 64, 66 may be stacked together so that they overlap, and the laser welding process may be performed so that the weld joints 72, 76, 80 extend through the joining regions 50 of the stacked exterior portions 46 of the tabs 34 and into their respective aluminum bus bars 682, 683, 684.

In another embodiment, and referring now to FIG. 8, the aluminum bus bars 68 may be omitted due to the fact that the negative terminal tabs 32 of one group of lithium ion battery pouch cells 14 may be directly fusion welded to the positive terminal tabs 34 of another group of lithium ion battery pouch cells 14. The direct welding of the tabs 32, 34 is possible because the joining regions 48, 50 of the exterior portions 44, 46 of the negative and positive terminal tabs 32, 34 are composed of the same (aluminum and aluminum) or similarly-weldable (aluminum and nickel-coated aluminum) materials. Accordingly, as shown here in FIG. 8, the joining regions 50 of the exterior portions 46 of the positive terminal tabs 34 of the first group 62 of pouch cells 14 may be directly fusion welded to the joining regions 48 of the exterior portions 44 of the negative terminal tabs 32 of the second group 64 of pouch cells 14 to serially connect the first and second groups 62, 64 of pouch cells 14 together within the lithium ion battery pack 60. When directly welding the tabs 32, 34 together, the negative and positive terminal tabs 32, 34 may be stacked as groups or they may be stacked in alternating fashion (as shown), and a weld joint 82 extends through the joining regions 48, 50 of all of the tabs 32, 34 to fusion weld the tabs 32, 32 together. The same direct fusion welding may also be performed to provide a weld joint 84 that fusion welds the joining regions 50 of the exterior portions 46 of the positive terminal tabs 34 of the second group 64 of pouch cells 14 to the joining regions 48 of the exterior portions 44 of the negative terminal tabs 32 of the third group 66 of pouch cells 14 to serially connect the second and third groups 64, 66 of pouch cells 14.

While only the first, second, and third groups 62, 64, 66 of lithium ion pouch cells 14 are shown electrically connected together either by aluminum bus bars 68 or through direct fusion welding, additional groups of lithium ion battery pouch cells 14 may be electrically connected to the groups 62, 64, 66 shown in FIGS. 7 and 8 in the same manners described above to complete the construction of the lithium ion battery pack 60. And, once in service, the lithium ion battery pack may be operated in the normal way to produce a useable electric current. For instance, during the discharge cycle, lithium ions and free electrons are released from the negative electrodes 16 of the lithium ion battery unit cells 14 when the external circuit that connects the lithium ion battery pack 60 to a load, such as an electric motor, is closed and a current draw is demanded. The electrons are collected by the negative-side metal collectors 22 and the lithium ions are conducted through the separators 20 towards the positive electrodes 18. The electrons continue to flow into the negative terminal tabs 32 of the lithium ion battery pouch cells 10 and through the remainder of the lithium ion battery pack 60 and eventually to the load drawing a current. After passing through the load, the electrons return to the lithium ion battery pack 60 and are supplied to the positive terminal tabs 32 of the lithium ion battery pouch cells 14. The electrons eventually travel to the positive-side metal current collectors 24 and into the positive electrodes 18 where they reunite with lithium ions. This electrochemical activity can be reversed during the charge cycle by applying an external voltage to the lithium ion battery pack 60.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

1. A lithium ion battery pack comprising:
a first group of lithium ion battery pouch cells, each of the lithium ion battery pouch cells in the first group comprising a negative terminal tab and a positive terminal tab, the negative terminal tab of each lithium ion battery pouch cell in the first group having an exterior portion that includes a joining region, and the positive terminal tab of each lithium ion battery pouch cell in the first group having an exterior portion that includes a joining region, the exterior portion of the positive terminal tab of each lithium ion battery pouch cell in the first group being composed of aluminum, and at least the joining region of the exterior portion of the negative terminal tab of each lithium ion battery pouch cell in the first group being composed of aluminum or nickel-coated aluminum; and
a second group of lithium ion battery pouch cells, each of the lithium ion battery pouch cells in the second group comprising a negative terminal tab and a positive terminal tab, the negative terminal tab of each lithium ion battery pouch cell in the second group having an exterior portion that includes a joining region, and the positive terminal tab of each lithium ion battery pouch cell in the second group having an exterior portion that includes a joining region, the exterior portion of the positive terminal tab of each lithium ion battery pouch cell in the second group being composed of aluminum, and at least the joining region of the exterior portion of the negative terminal tab of each lithium ion battery pouch cell in the second group being composed of aluminum or nickel-coated aluminum;
wherein the positive terminal tabs of the first group of lithium ion battery pouch cells are electrically connected to the negative terminal tabs of the second group of lithium ion battery pouch cells.

2. The lithium ion battery pack set forth in claim 1, further comprising:
an aluminum bus bar, wherein the joining region of the exterior portion of the positive terminal tab of each lithium ion battery pouch cell in the first group is welded to the aluminum bus bar, and wherein the joining region of the exterior portion of the negative terminal tab of each lithium ion battery pouch cell in the second group is welded to the aluminum bus bar.

3. The lithium ion battery pack set forth in claim 2, wherein the joining regions of the exterior portions of the positive terminal tabs of the lithium ion battery pouch cells in the first group are stacked together and overlap, and wherein a weld joint welds the joining regions of the exterior portions of the positive terminal tabs of the lithium ion battery pouch cells in the first group to each other as well as to the aluminum bus bar.

4. The lithium ion battery pack set forth in claim 2, wherein the joining regions of the exterior portions of the negative terminal tabs of the lithium ion battery pouch cells in the second group are stacked together and overlap, and wherein a weld joint welds the joining regions of the exterior portions of the negative terminal tabs of the lithium ion battery pouch cells in the second group to each other as well as to the aluminum bus bar.

5. The lithium ion battery pack set forth in claim 1, wherein the joining regions of the exterior portions of the positive terminal tabs of the lithium ion battery pouch cells in the first group are welded directly to the joining regions of the exterior portions of the negative terminal tabs of the lithium ion battery pouch cells in the second group.

6. The lithium ion battery pack set forth in claim 1, wherein the negative terminal tab of each lithium ion battery pouch cell of the second group includes a nickel segment and an aluminum segment, the nickel segment being electrically connected to a plurality of lithium ion battery unit cells within an envelope of its respective lithium ion battery pouch cell and further extending through the envelope of its respective lithium ion battery pouch cell, and the aluminum segment being joined to and extending from the nickel segment to provide the joining region of the exterior portion of the negative terminal tab of its respective lithium ion battery pouch cell.

7. The lithium ion battery pack set forth in claim 6, wherein the aluminum segment of the negative terminal tab of each lithium ion battery pouch cell comprises a majority of the exterior portion of the negative terminal tab of its respective lithium ion battery pouch cell.

8. The lithium ion battery pack set forth in claim 1, wherein at least the interior portion of the negative terminal tab of each lithium ion battery pouch cell of the second group is composed of nickel-coated aluminum.

9. The lithium ion battery pack set forth in claim 8, wherein the negative terminal tab of each lithium ion battery pouch cell of the second group is composed entirely of nickel-coated aluminum.

10. The lithium ion battery pack set forth in claim 1, further comprising:
a third group of lithium ion battery pouch cells, each of the lithium ion battery pouch cells in the third group comprising a negative terminal tab and a positive terminal tab, the negative terminal tab of each lithium ion battery pouch cell in the third group having an exterior portion that includes a joining region, and the positive terminal tab of each lithium ion battery pouch cell in the third group having an exterior portion that includes a joining region, the exterior portion of the positive terminal tab of each lithium ion battery pouch cell in the third group being composed of aluminum, and at least the joining region of the exterior portion of the negative terminal tab of each lithium ion battery pouch cell in the third group being composed of aluminum or nickel-coated aluminum, wherein the positive terminal tabs of the second group of lithium ion battery pouch cells are electrically connected to the negative terminal tabs of the third group of lithium ion battery pouch cells.

11. A lithium ion battery pack comprising:
a first group of lithium ion battery pouch cells, each of the first group of lithium ion battery pouch cells having a positive terminal tab that includes an exterior portion composed of aluminum; and
a second group of lithium ion battery pouch cells, each of the second group of lithium ion battery pouch cells having a negative terminal tab that includes an exterior portion, wherein at least part of the exterior portion of the negative terminal tab of each lithium ion battery cell in the second group is composed of aluminum or nickel-coated aluminum, and wherein the exterior portion of each positive terminal tab and the part of the exterior portion of each negative terminal tab that is composed of aluminum or nickel-coated aluminum are welded to a common aluminum bus bar or are directly welded together.

12. The lithium ion battery pack set forth in claim 11, wherein the negative terminal tab of at least one lithium ion battery pouch cell of the second group includes a nickel segment and an aluminum segment, the nickel segment being electrically connected to a plurality of lithium ion battery unit cells within an envelope of its respective lithium ion battery pouch cell and further extending through the envelope of its respective lithium ion battery pouch cell, and the aluminum segment being joined to and extending from the nickel segment.

13. The lithium ion battery pack set forth in claim 11, wherein the negative terminal tab of at least one lithium ion battery pouch cell of the second group is entirely composed of nickel-coated aluminum.

14. The lithium ion battery pack set forth in claim 11, wherein the negative terminal tab of at least one lithium ion battery pouch cell of the second group includes an interior portion, and wherein at least the interior portion of the negative terminal tab is composed of nickel-coated aluminum.

15. The lithium ion battery pack set forth in claim 11, wherein each of the lithium ion battery pouch cells in the second group further comprises a positive terminal tab that includes an exterior portion composed of aluminum, the lithium ion battery further comprising:
a third group of lithium ion battery pouch cells, each of the third group of lithium ion battery pouch cells having a negative terminal tab that includes an exterior portion, wherein at least part of the exterior portion of the negative terminal tab of each lithium ion battery pouch cell in the third group is composed of aluminum or nickel-coated aluminum, and wherein the exterior portions of positive terminal tabs of the second group of lithium ion battery pouch cells and the parts of the exterior portions of the negative terminal tabs of the lithium ion battery pouch cells in the third group that are composed of aluminum or nickel-coated aluminum are welded to a common aluminum bus bar or are directly welded together.

16. A lithium ion battery pouch cell comprising:
an envelope;
a plurality of lithium ion battery unit cells enclosed within the envelope, each of the lithium ion battery unit cells comprising a positive electrode, a negative electrode, and a separator disposed between the positive and negative electrodes;
a plurality of positive-side metal current collectors that are in contact with and exchange electrons with the positive electrodes of the plurality of lithium ion battery unit cells;
a plurality of negative-side metal current collectors that are in contact with and exchange electrons with the negative electrodes of the plurality of lithium ion battery unit cells;
a positive terminal tab that electrically communicates with the positive-side metal current collectors inside the envelope, the positive terminal tab extending through the envelope and having an exterior portion outside of the envelope, the positive terminal tab further being composed of aluminum; and
a negative terminal tab that electrically communicates with the negative-side metal current collectors inside the envelope, the negative terminal tab extending through the envelope and having an exterior portion outside of the envelope, and wherein at least a part of the exterior portion of the negative terminal tab is composed of aluminum or nickel-coated aluminum.

17. The lithium ion battery pouch cell set forth in claim 16, wherein the negative terminal tab includes a nickel segment and an aluminum segment, the nickel segment being electrically connected to the negative-side metal current collectors within the envelope and further extending through the envelope to provide part of the exterior portion of the negative terminal tab, and the aluminum segment being joined to and extending from the nickel segment to provide a remainder of the exterior portion of the negative terminal tab.

18. The lithium ion battery pouch cell set forth in claim 16, wherein the negative terminal tab is composed of nickel-coated aluminum.
